(19) United States
(12) Patent Application Publication
(10) Pub. No.: US 2006/0271597 A1
(43) Pub. Date: Nov. 30, 2006

(54) Code-enabled/code-free files

(75) Inventor: Kevin J. Boske, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/142,061

(22) Filed: May 31, 2005

(51) Int. Cl. G06F 17/30

(52) U.S. Cl. 707/200

(57) ABSTRACT

Implementations for determining whether a file contains code without opening the file. A file has a file extension that includes an indication of whether the file is to be code-free. In addition, the file contains an indicator (e.g., a content-type) that provides an indication of whether the file is to be code-free. Before opening the file, the file extension and the content-type are inspected to determine whether the file is to be opened. Also, a file that contains indications of being code-free but in fact includes code is prevented from being saved (or “saved-as”) Before saving the file, an application can inspect the aforementioned file extension and content-type to determine whether the file is being indicated as a code-free and then scan the file to determine if the file contains code to make sure that the code-free indications are accurate.

### BACKGROUND

Some application programs use and generate data files that can be opened, saved and saved as new data files. For example a word processing application can be used to generate and edit a text document (i.e., a type of data file). A file may include meta-data in addition to the data. Meta-data can be used, for example, to provide formatting information used in displaying and/or printing the data contained in the file. In addition, a file may include executable code (e.g., macros) that can be executed when a file is opened. For example, Visual Basic® for Applications (VBA) is a programming language implemented in Microsoft® Office, which is a suite of applications (e.g., word processing, spreadsheet, e-mail applications) available from Microsoft Corporation, Redmond, Wash. VBA can be used to write macros in data files of Microsoft® Office applications (and some other applications; e.g., AutoCad®). In some applications, the code can be automatically executed upon the data file being opened. However, the code included in a data file may be malicious code (e.g., a virus) that takes advantage of the automatic execution feature available in some applications. This background information is not intended to identify problems that must be addressed by the claimed subject matter.

### SUMMARY

This summary is provided to introduce a selection of concepts in a simplified form that are further described below in the Detail Description Section. This summary is not intended to identify key features or essential features of the claimed subject matter, nor is it intended to be used as an aid in determining the scope of the claimed subject matter.

According to aspects of various described embodiments, implementations for determining whether a file contains code without opening the file are provided. In one aspect, a file extension of a file includes an indication of whether the file is to be code-free. In addition, the file contains an indicator (e.g., a content-type) that provides an indication of whether the file is to be code-free. Before opening the file, the file extension and the content-type are inspected to determine whether the file is to be opened.

According to another aspect, a file that contains indications of being code-free but in fact includes code is prevented from being saved (or “saved-as”). For example, before saving the file, an application can inspect the aforementioned file extension and content-type to determine whether the file is being indicated as a code-free and then scan the file to determine if the file contains code to make sure that the code-free indications are accurate.

According to another aspect, detected code can be removed from files that are indicated as being code-free (either by the file extension, content-type or both).

Embodiments may be implemented as a computer process, a computer system (including mobile handheld computing devices) or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 is a diagram illustrating an exemplary system that can determine whether a file contains code without opening the file, according to one embodiment.

FIG. 2 is a diagram illustrating an application depicted in FIG. 1 that can save files with indications of whether the files may include code, and that can determine whether a file contains code without opening the file, according to one embodiment.

FIG. 3 is a flow diagram illustrating operational flow in opening a file, according to one embodiment.

FIG. 4 is a flow diagram illustrating operational flow in saving a file, according to one embodiment.

FIG. 5 is a flow diagram illustrating operational flow saving a file as a new file (i.e., “save as” operational flow), according to one embodiment.

FIG. 6 is a block diagram illustrating an exemplary computing environment suitable for implementing the systems and operational flow of FIGS. 1-5, according to one embodiment.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the embodiment. Accordingly, the logical operations making up the embodiments described herein are referred to alternatively as operations, steps or modules.

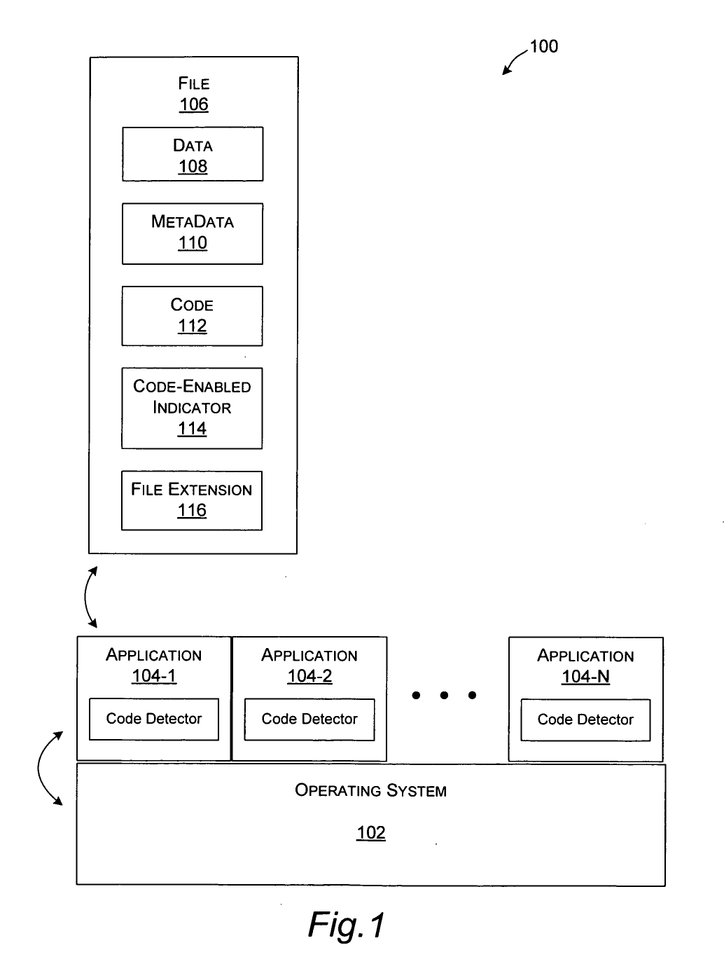

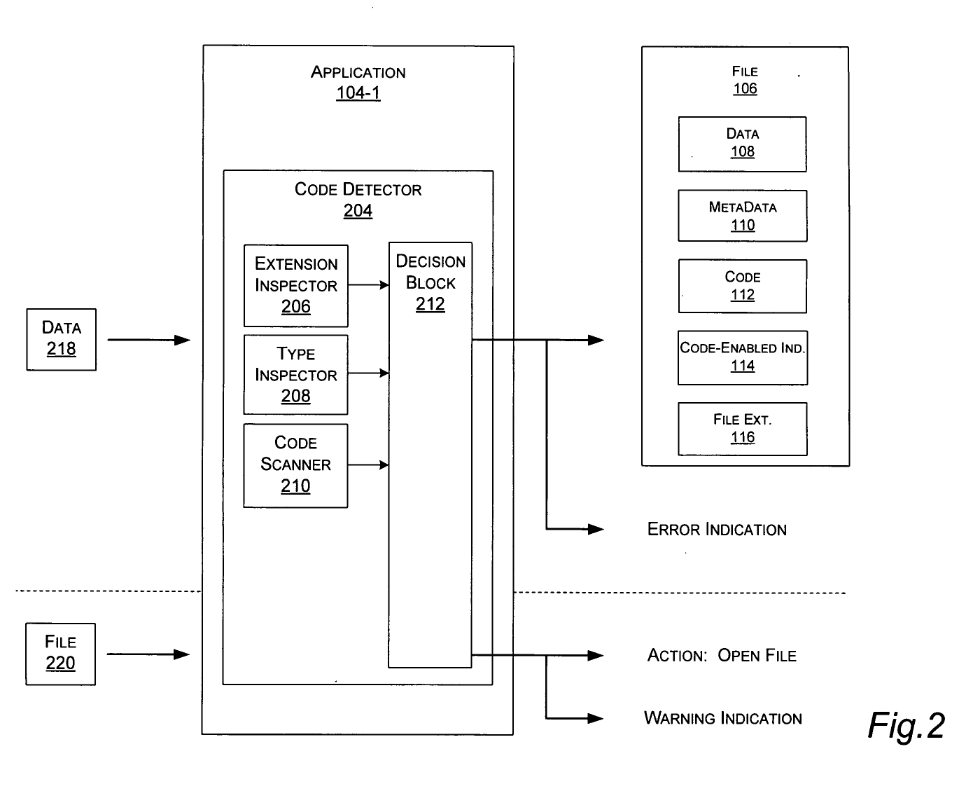

FIG. 1 illustrates an exemplary system 100 that can determine whether a file contains code without opening the file, according to one embodiment. In this embodiment, system 100 includes an operating system 102, applications 104-1 through 104-N, and a file 106. In this example embodiment, file 106 includes data 108, metadata 110, code 112, a code-enabled indicator 114 (e.g., a tag for files having a file format with markup, and/or a property if the file is object in an object oriented embodiment), and a file extension 116 (e.g., as part of the file name). Further, in accordance with this embodiment, applications 104-1 through 104-N each include a code detector module (also referred to herein simply as the code detector). The code detector, in some embodiments, can detect whether a file is enabled to contain code (e.g., has a code-enabled indicator that indicates that the file is macro-enabled) and/or actually contains code. In addition, in some embodiments, the code detector can prevent a file that contains code from being “saved” or “saved as” as file that is purported to be free of code. Various embodiments of the code detector module are described below in conjunction with FIGS. 2-5.

In operation, applications 104-1 through 104-N can communicate with operating system 102 for purposes such as, for example, accessing operating system functions. In addition, applications 104-1 through 104-N can, for example, open, edit, save, and/or create files. In the exemplary embodiment of FIG. 1, application 104-1 is shown interacting with file 106. For example, application 104-1 can be a word processing application, which a user can launch application 104-1 and then create a new document (e.g., file 106). The user can then add and edit text data (i.e., data 108) to file 106.

Formatting or other metadata 110 can also be added to file 106. For example, a user can format data 108 via a UI provided by application 104-1, which would then add the appropriate metadata to file 106. Alternatively, application 104-1 may have default values set for formatting or other metadata, which application 104-1 would automatically add to file 106.

Further, the user can add code 112 to file 106. For example, application 104-1 may include a macro-editor that allows a user to add/edit code in a file. The code can be used to provide application-specific functionality to the file such as, for example, creating an animation to be displayed as part of data 108, or alter data 108, or save the file 106, or edit metadata 110, etc.

Application 104-1 can then cause code-enabled indicator 114 to indicate that file 106 is code-enabled if it contains code 112 (or is intended to contain code), or to indicate that file 106 is code-free (and is intended to remain code-free) if it does not contain code. In some embodiments, file 106 can have a “content type” property or field to implement code-enabled indicator 114. For example, application 104-1 can prompt the use to select the “content-type” during a save or save-as operation, which serves to “configure” code-enabled indicator 114. In some embodiments, file 106 need not have code 112 in order to have code-enabled indicator 114 configured to indicate that the file is code-enabled. In some embodiments, application 104-1 is designed so that it cannot cause code-enabled indicator 114 to indicate that a file is code-free when the file in fact contains code.

Application 104-1 can then cause file extension 116 to indicate whether or not file 106 is code-enabled depending on whether or not code-enabled indicator 114 indicates that file 106 is code-enabled, and/or whether or not file 106 includes code. For example, in this embodiment file extension 116 is part of the file name of file 106 assigned to the file when the file is “saved” or “saved-as”. Application 104-1 is implemented so that a file generated/edited using application 104-1 will have one of set of predetermined extension defined for the application. In one embodiment, file extensions normally used for the application are modified so that a letter “x” is appended to the end of the standard file extension to indicate a code-free or macro-free file. Similarly, in that embodiment, a letter “c” or a letter “m” is appended to the standard file extension to indicate a code-enabled or macro-enabled file. For example, a word processing application can cause a file (i.e., a text document) to have a file extension of“.docx” to indicate a macro-free file, and a file extension of “.docm” to indicate a macro-enabled file.

In some embodiments, file 106 need not have code 112 in order to have file extension 116 configured to indicate that the file is code-enabled. In some embodiments, application 104-1 is designed so that it cannot configure file extension 116 to indicate that a file is code-free when the file in fact contains code.

File extension 116 can be advantageously used by an IT (information technology) administrator as a first cut at detecting or blocking potentially malicious files (i.e., files with code) before it received by a network. For example, an email server can be configured to detect and block all email with files having a code-enabled file extension, while allowing email with files having code-free file extensions to enter the email client network.

Code-enabled indicator 114 can be advantageously used by the application to identify whether the file can contain code or cannot contain code. In one embodiment, code-enabled indicator 114 is implemented as content type (or a subtype of a content type), as defined in a file format for the files generated/used by an application (or group of applications). One advantage of the content type is that it provides a mechanism to facilitate detection of code or macros in a file without having to scan the entire file.

Further, in some embodiments the file format may allow an application to define a relationship or link between various parts of a file. For example, data 108 may be related to metadata 110 and code 112 by explicit “relationship” links defined in the file. This feature allows an application or other component to locate part(s) of a file. For example, an application can easily locate a code part of a file using relationships defined in the file and then, optionally, delete the code from the file. This feature may be advantageous in scenarios in which a file extension or content type indicates a code-free file, but the file actually contains code. The code can be located using the relationships defined in the file, and then removed by the application to prevent the execution of malicious code.

Still further, in some embodiments, file 106 may be implemented as an object in an object-oriented system. File 106 can then include one or more methods or functions that determine whether there is code in the file, and return a Boolean value based on the determination. The method(s) or function(s) can be exposed as part of an application program interface (API). The method can use the aforementioned relationships as specified by the file format to determine whether the file contains code.

FIG. 2 illustrates an embodiment of application 104-1 (FIG. 1), according to one embodiment. In this exemplary embodiment, application 104-1 includes a code detector 204 that includes an extension inspector 206, a type inspector 208, a code scanner 210 and a decision block 212. Extension inspector 206 operates to inspect a file extension such as file extension 116 (FIG. 1) and determine whether the file extension indicates the file is a code-free file or a code-enabled file. The file extension may be from the file name of an opened or unopened file, or can be received via user input in creating or generating a new file.

Type inspector 208 can inspect a code-enabled indicator such as code-enabled indicator 114 (FIG. 1). In one embodiment, the code-enabled indicator is a content type as previously described in conjunction with FIG. 1.

Code scanner 210 can inspect or scan data or a file for code. In one embodiment, code scanner 210 can inspect the file or data for commands or instructions that form the code. In other embodiments, code scanner 210 can inspect the data or file for relationship(s) (described above in conjunction with FIG. 1) that are defined in the file or data identifying code.

Decision block 212 can process information from extension inspector 206, type inspector 208 and code scanner 210 and determine an action regarding the data or file. For example, in one embodiment, decision block 212 can process the information from extension inspector 206, type inspector 208 and code scanner 210 and determine whether application 104-1 should perform operations such as: (a) open a file; (b) generate a new file (e.g., by performing a save-as operation); or (c) update data, metadata, code, etc. in a file (e.g., by performing a save operation).

In one operational mode, application 104-1 receives data (e.g., data 218) to be saved in a file via a save operation or a save-as operation. For example, data 218 can be an opened file that has been edited (or unedited). Code detector 204 then processes data 218 and can output either a file such as file 106, or cause the application to perform an action such as providing an error indication to the user. For example, in one embodiment, if data 218 does not include code (as indicated by code scanner 210), decision block 212 can cause application 104-1 to perform a save (or save-as) operation no matter what values of file extension and content-type are provided by the user. In this way, application 104-1, in effect, outputs a file such as file 106. If data 218 contains code and the user attempted to save (or save-as) the file with a “code-free” file extension or content-type, decision block 212 may cause application 104-1 to provide an error message and prevent saving (or saving-as) of data 218 in a file.

In another operational mode, application 104-1 receives a file (e.g., a file 220) to be opened. Code detector 204 then processes file 220 and can cause the application to either open the file, or cause the application to provide a warning indication to the user to warn the user that the file may contain malicious code (or other appropriate message or action). For example, in one embodiment, if file 220 does not include code (as indicated by code scanner 210), decision block 212 can cause application 104-1 to perform an “open file” operation for all combinations of file extension and content-type values. If file 220 has a “code-free” file extension and/or content-type but contains code, decision block 212 may cause application 104-1 to provide an error or warning message and prevent opening of file 220.

Table 1 below illustrates the behavior of decision block 212 in response to various scenarios of file extension, content type and code, according to one embodiment.

TABLE 1

| | | Code | |
|---|---|---|---|
| File Extension | Content Type | Present | Action |
| Code-enabled | Code-enabled | No | Open file/save file/save-as file |
| Code-enabled | Code-enabled | Yes | Open file/save file/save-as file |
| Code-enabled | Code-free | No | Open file/save file/save-as file |
| Code-enabled | Code-free | Yes | Do not open or save or save- |
| | | | as |
| Code-free | Code-enabled | No | Open file/save file/save-as file |
| Code-free | Code-enabled | Yes | Do not open or save or save- |
| | | | as |
| Code-free | Code-free | No | Open file/save file/save-as file |
| Code-free | Code-free | Yes | Do not open or save or save- |
| | | | as |

In one embodiment, the values for file extension, content-type and code present are respectively provided by extension detector 206, type detector 208 and code scanner 210.

### Exemplary “Open File” Operational Flow

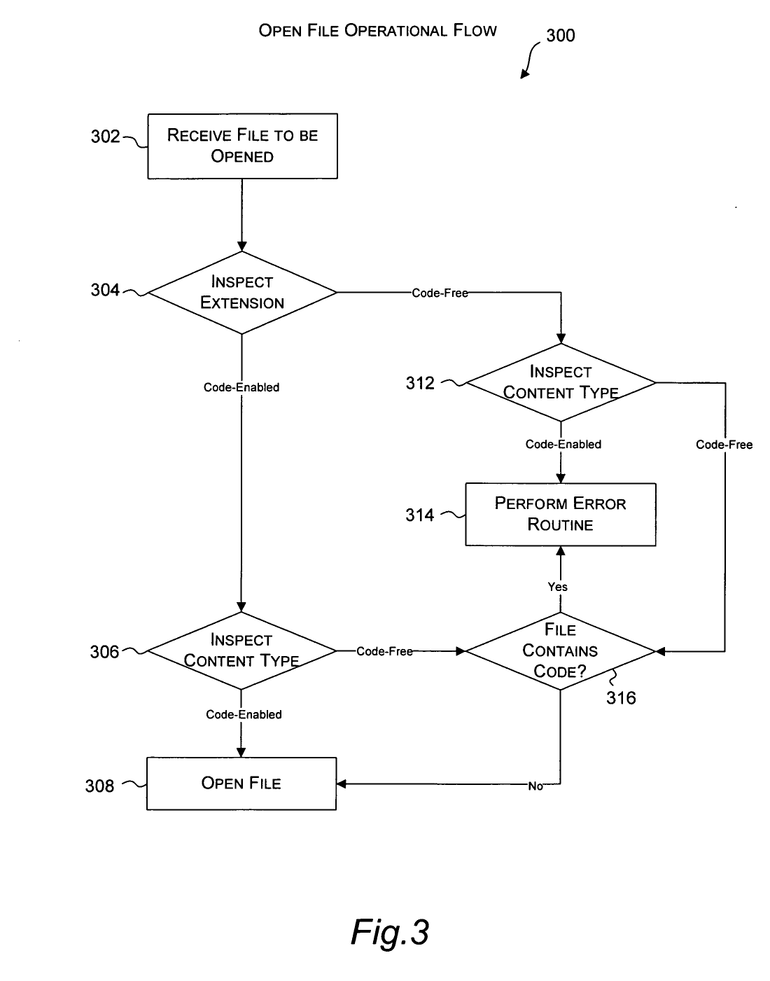

FIG. 3 illustrates an operational flow 300 for opening a file, according to one embodiment. Operational flow 300 may be performed in any suitable computing environment. For example, operational flow 300 may be executed by an application such as application 104-1 (FIG. 2) to open a file. Therefore, the description of operational flow 300 may refer to at least one of the components of FIG. 2. However, any such reference to components of FIG. 2 is for descriptive purposes only, and it is to be understood that the implementations of FIG. 2 are a non-limiting environment for operational flow 300.

At a block 302, a file to be opened is received. In one embodiment, an application such as application 104-1 (FIG. 2) is used to open the file. For example, a user may attempt to open the file by launching an application and then selecting the file. In some embodiments, the user can select a file, which may automatically launch an appropriate application to open the file (or prompt the user to select an application to open the file).

At a block 304, the file extension of the file is inspected to determine if the file is code-enabled/code-free. In one embodiment, an application having a file extension inspector such as extension inspector 206 (FIG. 2) can inspect the file extension before the file is opened. If it is determined that the file extension indicates that the file is code-enabled, operational flow 300 can proceed to a block 306 described below. However, if it is determined that the file extension indicates that the file is code-free, operational flow 300 can proceed to a block 312, described below.

At block 306, the content-type of the file is inspected. In one embodiment, an application having a content-type inspector such as type inspector 208 (FIG. 2) can inspect the file's content type before the file is opened. If it is determined that the file's content-type indicates that the file is code-enabled, operational flow 300 can proceed to a block 308 described below. However, if it is determined that the content-type indicates that that the file is code-free, operational flow 300 can proceed to a block 316, described below.

At block 308, the file is opened. In this situation, the file extension and the content-type both indicate that the file may contain code, it is assumed that there is no attempt to mislead the user of the possibility of the file containing code. Therefore, the file is opened assuming that the user is aware of the risk but has chosen to open the file anyway. In one embodiment, a decision block such as decision block 212 (FIG. 2) causes the application to open the file. In some scenarios, opening the file can cause the application to automatically execute code if any is contained in the file. Returning to decision block 304, if the file extension is determined to indicate a code-free file, as previously described, operational flow 300 can proceed to block 312.

At block 312, the content-type is inspected. In one embodiment, the content-type is inspected as previously described for block 306. If it is determined that the file's content-type indicates that the file is code-enabled, operational flow 300 can proceed to a block 314 described below. However, if it is determined that the content-type indicates that that the file is code-free, operational flow 300 can proceed to aforementioned block 316, which is described in more detail below.

At block 314, an error routine is performed. In one embodiment, a decision block such as decision block 212 causes the application to perform the error routine. Because the file extension indicates that the file is code-free yet the content-type indicates that the file may contain code, it is assumed that the creator of the file has made an error in the file extension, or worse, is trying to mislead the user into believing the file is code-free.

The error routine may include providing a message to the user that the file cannot be opened because it may contain code. In other embodiments, the error routine may also provide the user an option to delete the code and open the file after the code has been deleted. In embodiments in which the file has defined relationships (described above), the application may easily locate the code for deletion by inspecting the relationships defined in the file. In still other embodiments, the error routine may also provide the user an option to override the application and open the file anyway.

Referring again to blocks 306 and 312, if the content type indicates that the file is code-free, operational flow 300 can proceed to block 316.

At block 316, the file is scanned to determine if the file contains code despite the content type indicating that the file should be code-free. In one embodiment, a code scanner such as code scanner 210 (FIG. 2) scans the file to find code. If it is determined that the file does contain code, operational flow 300 can proceed to block 314 to perform an error routine as previously described. However, if it is determined that the file does not contain code, then operational flow 300 can proceed to block 308 to open the file as previously described.

Although operational flow 300 is illustrated and described sequentially in a particular order, in other embodiments, the operations described in the blocks may be performed in different orders, multiple times, and/or in parallel. Further, one or more operations described in the blocks may be omitted or combined in some embodiments.

Exemplary “Save File” Operational Flow

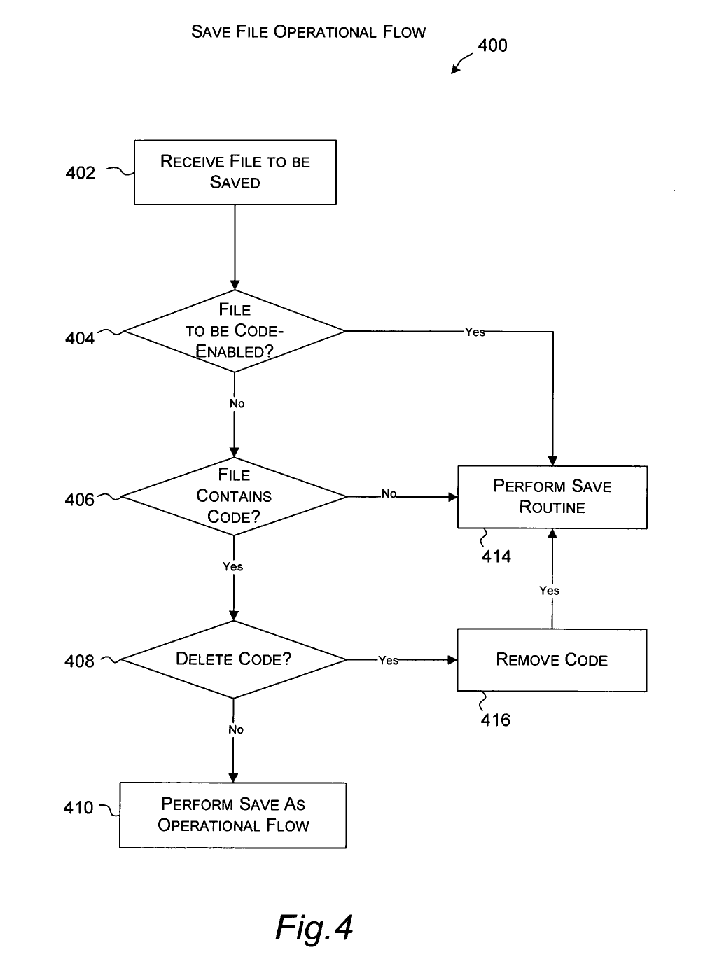

FIG. 4 illustrates an operational flow 400 in saving a file, according to one embodiment. Operational flow 400 may be performed in any suitable computing environment. For example, operational flow 400 may be executed by an application such as application 104-1 (FIG. 2) to open a file. Therefore, the description of operational flow 400 may refer to at least one of the components of FIG. 2. However, any such reference to components of FIG. 2 is for descriptive purposes only, and it is to be understood that the implementations of FIG. 2 are a non-limiting environment for operational flow 400.

At a block 402, a file to be saved is received. In one embodiment, an application such as application 104-1 (FIG. 2) is used to save the file. For example, a user may edit an existing file by launching the application, opening the file, and then editing the file. The user can then cause the application to perform a save operation to save the edits in the existing file. Alternatively, the user can select and open a file to be edited, which cause the operating system (e.g., operating system 102 in FIG. 1) to automatically launch an appropriate application to open the existing file (or prompt the user to select an application to open the file). In some embodiments, the application can also be configured to automatically save an opened file periodically.

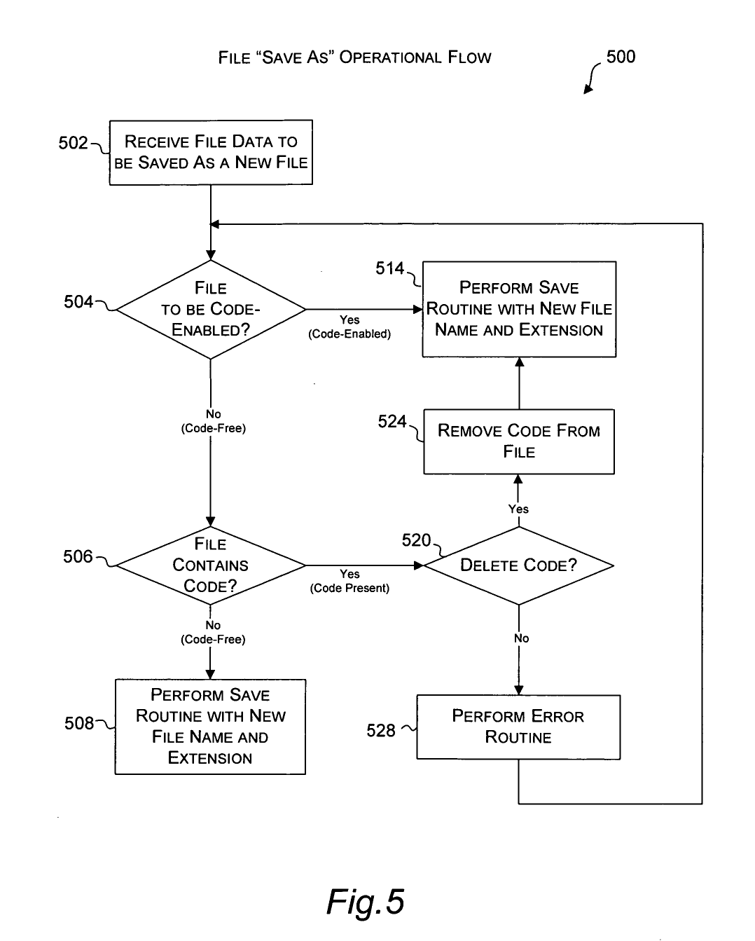

For a file that has just been created (i.e., a new file), the initial save operation is performed in one embodiment by performing a “saved-as” operational flow as described below in conjunction with FIG. 5.

At a block 404, it is determined whether the file is a code-enabled file. In one embodiment, the file extension and the content-type are inspected to determine if the file is a code-enabled file. For example, in one embodiment, a decision block such as decision block 212 (FIG. 2) determines whether the file is a code-enabled file by receiving information from a file extension inspector such as extension inspector 206 (FIG. 2) and a content-type inspector such as type inspector 208 (FIG. 2). If it is determined that the file is a code-enabled file, operational flow 400 can proceed to a block 414, which is described below. However, if it is determined that the file is a code-free file, operational flow 400 can proceed to a block 406.

At block 406, it is determined whether the file contains code. In one embodiment, a code scanner such as code scanner 210 (FIG. 2) scans the file to find code. For example, in embodiments in which the file is an object, the code scanner can call a method on the file object to determine if the file has code and appropriately set a “has code” property of the file object. In embodiments in which the file has relationships (described above), the code scanner (or file object method) can inspect the relationships to determine if the file contains code. If it is determined that the file does not contain code, operational flow 400 can proceed to aforementioned block 414 (described in more detail below). However, if it is determined that the file does contain code, operational flow 400 can proceed to a block 408.

At block 408, it is determined whether to delete the code contained in the file. In one embodiment, the application can provide an indication to the user than the file cannot be saved because it is indicated as being code-free but has code. In addition, in this embodiment, the application can provide the user an option to delete the code. If it is determined that the code is to be deleted, operational flow can proceed to a block 416, which is described below. However, if it is determined that the code is not to be deleted, operational flow 400 can proceed to a block 410.

At block 410, a save-as operational flow is performed. In one embodiment, block 410 is performed as described below in conjunction with FIG. 5. Block 410 allows the user to create a new file and change both the file extension and the content-type to indicate that the new file contains code. Returning to block 404, if it is determined that the file is a code-enabled file (or if it is determined that the file does not contain code at block 406), as previously described, operational flow 400 can proceed to block 414.

At block 414, a save routine is performed. In one embodiment, the application saves the file in a standard manner. In this embodiment, no determination is made as to whether the file actually contains code because the file extension and content-type only indicate that the file is code-enabled (i.e., capable of containing code). The user may intend to add code later if the file currently does not contain code. Even if the file does not contain code, saving the file is permitted because opening the code-free file will be safe for all users and does not mislead a user into believing a file is safe to open when in fact it is not. In alternative embodiments, the file may be scanned to determine if it contains code and if it does not, the application can prompt the user to confirm that the file is intended to be saved as a code-enabled file. Returning to block 408, if it is determined that the code is to be deleted, as previously mentioned, operational flow can proceed to block 416.

At block 416, code is removed from the file. In one embodiment, the application has a module to delete the code. In embodiments in which the file has defined relationships (described above), the application may easily locate the code for deletion by inspecting the relationships defined in the file. The relationship(s) linking code to the data are also removed. In embodiments in which the file is an object, the file object may include a method to delete the code. At block 416, the application can then call the method on the file object to delete the code. Deleting the code also includes simply not saving the code, which can allow the code to remain in memory. In some embodiments, the file may have code distributed throughout the file, and the application is implemented to perform a transformation process to convert the file into a code-free file. Operational flow 400 can then proceed to previously-described block 414 to save the file (which now is code-free).

Although operational flow 400 is illustrated and described sequentially in a particular order, in other embodiments, the operations described in the blocks may be performed in different orders, multiple times, and/or in parallel. Further, one or more operations described in the blocks may be omitted or combined in some embodiments.

Exemplar “Save-As” Operational Flow

FIG. 5 is a flow diagram illustrating operational flow saving a file as a new file (i.e., “save as” operational flow), according to one embodiment. Operational flow 500 may be performed in any suitable computing environment. For example, operational flow 500 may be executed by an application such as application 104-1 (FIG. 2) to open a file. Therefore, the description of operational flow 500 may refer to at least one of the components of FIG. 2. However, any such reference to components of FIG. 2 is for descriptive purposes only, and it is to be understood that the implementations of FIG. 2 are a non-limiting environment for operational flow 500.

At a block 502, a file to be “saved-as” is received. In one embodiment, an application such as application 104-1 (FIG. 2) is used to save-as the file. For example, a user may have a file to be “saved-as” by launching the application, opening the file, and then editing the file. The user can then cause the application to perform a save-as operational flow to save the edited file as a new file. Alternatively, the user can select and open a file to be edited, which may automatically launch an appropriate application to open the file (or prompt the user to select an application to open the file). The user can then cause the application to perform a save-as operation to save the edited file as a new file.

At a block 504, it is determined whether the file is intended to be saved as a code-enabled file. In one embodiment, the application prompts the user to enter a file name (with file extension) and select a content-type. The entered file extension and the selected content-type are inspected to determine if the file is intended to be saved as a code-enabled file. For example, in one embodiment, a decision block such as decision block 212 (FIG. 2) determines whether the file is intended to be saved as a code-enabled file by receiving information from a file extension inspector such as extension inspector 206 (FIG. 2) and from a code-enabled indicator inspector such as type inspector 208 (FIG. 2). If it is determined that it is intended to save the file as code-enabled file, operational flow 500 can proceed to a block 514, which is described below. However, if it is determined that it is intended to save the file as a code-free file, operational flow 500 can proceed to a block 506.

At block 506, it is determined whether the file contains code. In one embodiment, a code scanner such as code scanner 210 (FIG. 2) scans the file to find code. For example, in embodiments in which the file is an object, the code scanner can call a method on the file object to determine if the file has code and appropriately set a “has code” property of the file object. In embodiments in which the file has relationships (described above), the code scanner (or file object method) can inspect the relationships to determine if the file contains code. If it is determined that the file does contain code, operational flow 500 can proceed to a block 520 (described in more detail below). However, if it is determined that the file does not contain code, operational flow 500 can proceed to a block 508.

At block 508, the file is saved as a new file with the file extension and content-type obtained as described above in conjunction with block 504. In this example, the file will have a file extension such as file extension 116 (FIG. 1) that indicates that the file is code-free. In addition, the file will have a code-enabled indicator (e.g., content-type) such as code-enabled indicator 114 (FIG. 1) that indicates that the file is code-free. In some embodiments, the file name is checked to verify that it is not already being used. If the file name is already being used, the application can prompt the user for a new name and/or confirm whether the user wishes to overwrite the existing file with the same file name. Returning to block 504, if it is determined that the file is to be a code-enabled file, as previously described, operational flow 500 can proceed to block 514.

At block 514, the file is saved as a new file with the file extension and content-type obtained as described above in conjunction with block 504. In one embodiment, block 514 is performed as described above for block 508, except that the file will have a file extension such as file extension 116 (FIG. 1) that indicates that the file is code-enabled. In addition, the file will have a code-enabled indicator (e.g., content-type) such as code-enabled indicator 114 (FIG. 1) that indicates that the file is code-enabled. Returning to block 506, if it is determined that the file does contain code, as previously mentioned, operational flow 500 can proceed to block 520.

At block 520, it is determined whether to delete the code contained in the file. In one embodiment, the application can provide the user an option to delete the code. If it is determined that the code is not to be deleted, operational flow 500 can proceed to a block 528 (described further below). However, if it is determined that the code is to be deleted, operational flow can proceed to a block 524.

At block 524, code is removed from the file. In one embodiment, the application has a module to remove the code. Removing the code can be actually deleting the code, simply not saving the code, or transforming the file so that only data is retained. In embodiments in which the file has defined relationships (described above), the application may easily locate the code for deletion by inspecting the relationships defined in the file. The relationship(s) linking code to the data are also removed. In embodiments in which the file is an object, the file object may include a method to delete the code. At block 524, the application can then call the method on the file object to delete the code. Operational flow 500 can then proceed to previously-described block 514 to save the file (which now is code-free). Returning to block 520, if it is determined that the code is not to be deleted, as previously mentioned, operational flow 500 can proceed to block 528.

At block 528, an error routine is provided to the user. In one embodiment, the application can provide an indication to the user than the file cannot be saved because it is indicated as being code-free but has code. Operational flow 500 can then return to block 504 to obtain a file extension and code-enabled indication (e.g. content-type) from the user. Because the user does not want to delete the code, returning to block 504 will allow the user to change the file extension and content-type to indicate that the file is code-enabled. In this embodiment, operational flow 500 will not allow a file that contains code to be “saved-as” with a file extension and/or content type that indicates the file is code-free.

Although operational flow 500 is illustrated and described sequentially in a particular order, in other embodiments, the operations described in the blocks may be performed in different orders, multiple times, and/or in parallel. Further, one or more operations described in the blocks may be omitted or combined in some embodiments.

Illustrative Operating Environment

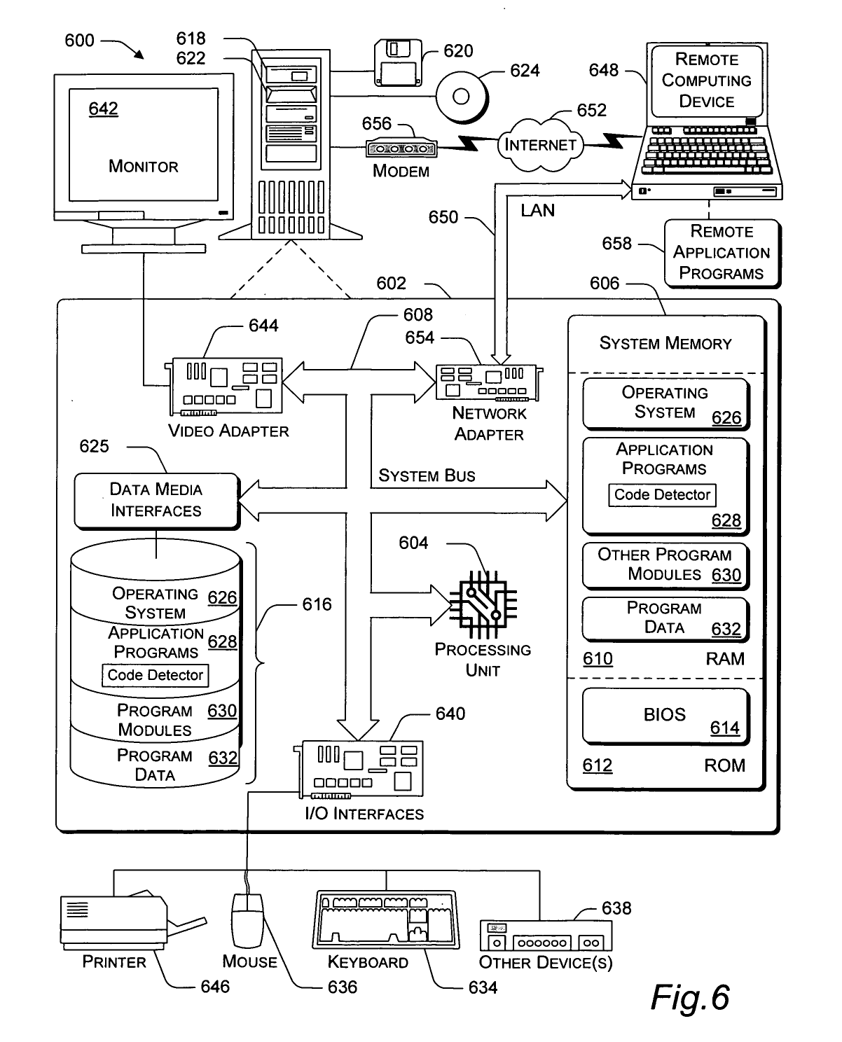

FIG. 6 illustrates a general computer environment 600, which can be used to implement the techniques described herein. The computer environment 600 is only one example of a computing environment and is not intended to suggest any limitation as to the scope of use or functionality of the computer and network architectures. Neither should the computer environment 600 be interpreted as having any dependency or requirement relating to any one or combination of components illustrated in the example computer environment 600.

Computer environment 600 includes a general-purpose computing device in the form of a computer 602. The components of computer 602 can include, but are not limited to, one or more processors or processing units 604, system memory 606, and system bus 608 that couples various system components including processor 604 to system memory 606.

System bus 608 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, a PCI Express bus, a Universal Serial Bus (USB), a Secure Digital (SD) bus, or an IEEE 1394, i.e., FireWire, bus.

Computer 602 may include a variety of computer readable media. Such media can be any available media that is accessible by computer 602 and includes both volatile and non-volatile media, removable and non-removable media.

System memory 606 includes computer readable media in the form of volatile memory, such as random access memory (RAM) 610; and/or non-volatile memory, such as read only memory (ROM) 612 or flash RAM. Basic input/output system (BIOS) 614, containing the basic routines that help to transfer information between elements within computer 602, such as during start-up, is stored in ROM 612 or flash RAM. RAM 610 typically contains data and/or program modules that are immediately accessible to and/or presently operated on by processing unit 604.

Computer 602 may also include other removable/non-removable, volatile/non-volatile computer storage media. By way of example, FIG. 6 illustrates hard disk drive 616 for reading from and writing to a non-removable, non-volatile magnetic media (not shown), magnetic disk drive 618 for reading from and writing to removable, non-volatile magnetic disk 620 (e.g., a “floppy disk”), and optical disk drive 622 for reading from and/or writing to a removable, non-volatile optical disk 624 such as a CD-ROM, DVD-ROM, or other optical media. Hard disk drive 616, magnetic disk drive 618, and optical disk drive 622 are each connected to system bus 608 by one or more data media interfaces 625. Alternatively, hard disk drive 616, magnetic disk drive 618, and optical disk drive 622 can be connected to the system bus 608 by one or more interfaces (not shown).

The disk drives and their associated computer-readable media provide non-volatile storage of computer readable instructions, data structures, program modules, and other data for computer 602. Although the example illustrates a hard disk 616, removable magnetic disk 620, and removable optical disk 624, it is appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the example computing system and environment.

Any number of program modules can be stored on hard disk 616, magnetic disk 620, optical disk 624, ROM 612, and/or RAM 610, including by way of example, operating system 626, one or more application programs 628 (which can include code detectors as described above), other program modules 630, and program data 632. Each of such operating system 626, one or more application programs 628, other program modules 630, and program data 632 (or some combination thereof) may implement all or part of the resident components that support the distributed file system.

A user can enter commands and information into computer 602 via input devices such as keyboard 634 and a pointing device 636 (e.g., a “mouse”). Other input devices 638 (not shown specifically) may include a microphone, joystick, game pad, satellite dish, serial port, scanner, and/or the like. These and other input devices are connected to processing unit 604 via input/output interfaces 640 that are coupled to system bus 608, but may be connected by other interface and bus structures, such as a parallel port, game port, or a universal serial bus (USB).

Monitor 642 or other type of display device can also be connected to the system bus 608 via an interface, such as video adapter 644. In addition to monitor 642, other output peripheral devices can include components such as speakers (not shown) and printer 646 which can be connected to computer 602 via 1/O interfaces 640.

Computer 602 can operate in a networked environment using logical connections to one or more remote computers, such as remote computing device 648. By way of example, remote computing device 648 can be a PC, portable computer, a server, a router, a network computer, a peer device or other common network node, and the like. Remote computing device 648 is illustrated as a portable computer that can include many or all of the elements and features described herein relative to computer 602. Alternatively, computer 602 can operate in a non-networked environment as well.

Logical connections between computer 602 and remote computer 648 are depicted as a local area network (LAN) 650 and a general wide area network (WAN) 652. Such networking environments are commonplace in offices, enterprise-wide computer networks, intranets, and the Internet.

When implemented in a LAN networking environment, computer 602 is connected to local network 650 via network interface or adapter 654. When implemented in a WAN networking environment, computer 602 typically includes modem 656 or other means for establishing communications over wide network 652. Modem 656, which can be internal or external to computer 602, can be connected to system bus 608 via I/O interfaces 640 or other appropriate mechanisms. It is to be appreciated that the illustrated network connections are examples and that other means of establishing at least one communication link between computers 602 and 648 can be employed.

In a networked environment, such as that illustrated with computing environment 600, program modules depicted relative to computer 602, or portions thereof, may be stored in a remote memory storage device. By way of example, remote application programs 658 reside on a memory device of remote computer 648. For purposes of illustration, applications or programs and other executable program components such as the operating system are illustrated herein as discrete blocks, although it is recognized that such programs and components reside at various times in different storage components of computing device 602, and are executed by at least one data processor of the computer.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

What is claimed is:

1. A computer-implemented method for opening a file, the method comprising:
receiving a file to be opened;
inspecting a file extension of the file, wherein the file extension is to indicate whether the file has code;
inspecting a content type of the file, wherein the content type is to indicate whether the file has code; and
determining whether to open the file based at least in part on the file extension and the content type.

2. The method of claim 1 further comprising determining whether the file contains code when the file extension and content type indicate that the file does not contain code.

3. The method of claim 1 further comprising determining whether the file contains code when the file extension indicates that the file may contain code and the content-type indicates that the file does not contain code.

4. The method of claim 1 further comprising opening the file if the file extension and the content type indicate that the file contains code.

5. The method of claim 1 further comprising not opening the file if the file extension indicates that the file is code-free and the content-type indicates that the file may contain code.

6. The method of claim 2 further comprising not opening the file if the file extension indicates that the file may contain code, the content-type indicates that the file does not contain code and the file contains code.

7. The method of claim 2 further comprising not opening the file if the file extension and content-type indicate that the file does not contain code, the content-type indicates that the file does not contain code and the file contains code.

8. The method of claim 2 further comprising opening the file if the file extension and content-type indicate that the file does not contain code, the content-type indicates that the file does not contain code and the file does not contain code.

9. A computer-implemented method for saving a file, the method comprising:
receiving a file to be saved;
inspecting the file to determine whether the file contains an indication that the file may contain code;
saving the file in response to determining that the file contains an indication that the file may contain code; and
determining whether to the file contains code in response to determining that the file contains no indication that the file may contain code.

10. The method of claim 9 wherein inspecting the file comprises inspecting a file extension of the file and inspecting a content-type of the file.

11. The method of claim 9 wherein determining whether the file contains code further comprises saving the file if it is determined that the file does not contain code.

12. The method of claim 9 wherein determining whether the file contains code further comprises determining whether to remove the code if it is determined that the file does contain code.

13. The method of claim 12 further comprising removing the code and saving the file after the code is removed in response to determining that the code is to be removed from the file.

14. The method of claim 12 further comprising saving the file as a new file in response to determining that the code is not to be removed from the file.

15. A computer-implemented method for saving a new file, the method comprising:
receiving a data to be saved in a new file;
determining whether the file is to contain an indication that the file may contain code;
saving the file in response to determining that the file is to contain an indication that the file may contain code; and
determining whether to the file contains code in response to determining that the file is to contain an indication that the file will not contain code.

16. The method of claim 15 wherein determining whether the file is to contain an indication that the file may contain code comprises obtaining a file extension for the file and a content-type for the file.

17. The method of claim 15 wherein determining whether the file contains code further comprises saving the file if it is determined that the file does not contain code.

18. The method of claim 15 wherein determining whether the file contains code further comprises determining whether to remove the code if it is determined that the file does contain code.

19. The method of claim 18 further comprising removing the code and saving the file after the code is removed in response to determining that the code is to be removed from the file.

20. The method of claim 18 further comprising providing an error notification in response to determining that the code is not to be removed from the file.
